(19) United States
(12) Patent Application Publication
(10) Pub. No.: US 2026/0312935 A1
(43) Pub. Date: Oct. 8, 2026

(54) METHOD FOR COOPERATIVELY FILTERING DATA TRAFFIC IN A COMMUNICATION NETWORK

(71) Applicant: Robert Bosch GmbH, Stuttgart (DE)

(72) Inventors: Abdulkadir Karaagac, Renningen (DE); Jan Hoffmann, Pforzheim (DE); Marie-Theres Suer, Braunschweig (DE)

(21) Appl. No.: 19/577,601

(22) Filed: Mar. 25, 2026

(30) Foreign Application Priority Data
Apr. 4, 2025 (DE) 10 2025 113 215.1

(51) Int. Cl. H04L 9/40

(52) U.S. Cl. CPC H04L 63/0236; H04L 63/0263; H04L 63/0435

(57) ABSTRACT

A method for cooperatively filtering data traffic in a communication network. The method includes: filtering the data traffic on the basis of first filter rules using a first security filter module; inserting a description of the first filter rules into the filtered data traffic; filtering the filtered data traffic on the basis of second filter rules using a second security filter module, taking into account the inserted description of the first filter rules. A computer program, a device, and a storage medium are also described.

### FIELD

The present disclosure relates to a method for cooperatively filtering data traffic in a communication network. The present disclosure furthermore relates to a computer program, a device, and a storage medium for this purpose.

### BACKGROUND INFORMATION

Security filter modules such as firewalls are widely recognized as essential components for protecting industrial systems from unauthorized access and cyber threats. They play a crucial role in filtering network traffic, preventing data leaks, and ensuring the integrity of critical operations. Traditional security filter modules have been widely used in industrial communication networks to ensure these security measures. However, industrial systems are evolving rapidly, driven by technological advances and the need for greater efficiency. This transformation brings new challenges and requirements for network and security measures.

Industrial communication networks often operate in real-time environments where even minor delays or interruptions can have serious consequences. Therefore, there is a growing need for more robust network and security solutions, including specialized security filter modules, to address these specific challenges and cover a wider range of use cases, such as low-latency and time-critical applications, using existing hardware. Nowadays, security filter modules in network configurations are usually implemented as individual units. However, network administrators are increasingly relying on dual configurations to improve performance, security, and fault tolerance. This approach involves implementing multiple security filter modules in parallel or sequentially, which enables load balancing and improved overall system stability. In a series connection, all network traffic must pass through both security filter modules. This configuration is often used in high-security environments to minimize security-filter-module-specific vulnerabilities or to protect multiple subnets within the internal communication network with different security requirements.

### SUMMARY

The subject matter of the present disclosure includes a method for cooperatively filtering data traffic in a communication network, a computer program, and a computer-readable storage medium. Features and details of the subject matter are disclosed herein. Features and details that are described in connection with the method according to the present disclosure of course also apply in connection with the computer program according to the present disclosure, the device according to the present disclosure, and the computer-readable storage medium according to the present disclosure, and vice versa in each case, so that mutual reference can also always be made with regard to the present disclosure.

The subject matter of the present disclosure includes, in particular, a method for cooperatively filtering data traffic in a communication network. According to an example embodiment, the method comprises:
filtering the data traffic on the basis of first filter rules using a first security filter module, wherein a security filter module within the scope of the present disclosure can also be referred to and understood, in particular, as a firewall,
inserting a description of the first filter rules into the filtered data traffic, in particular into individual data packets that are still present after filtering,
filtering the filtered data traffic on the basis of second filter rules, which differ preferably at least partially and particularly preferably completely from the first filter rules, using a second security filter module, taking into account the inserted description of the first filter rules, wherein the first filter rules are taken into account in particular by not being used again for filtering by the second security filter module.

The respective filter rules allow data traffic in the communication network to be selectively filtered by the relevant security filter module or firewall. The filter rules are based, for example, on attributes of individual data packets of the data traffic, such as source and destination IP address, source and destination port, protocol type (e.g., TCP, UDP) and further metadata. As part of the filtering, the relevant security filter module checks in particular each incoming or outgoing data packet against these filter rules and decides, on the basis of the defined criteria, whether the data packet should be allowed to pass through, blocked or modified, if necessary. In this way, data traffic can be controlled by filtering to prevent unauthorized access, protect network resources, and implement security-related requirements.

A description can be understood to mean a data structure that contains information about the first filter rules applied by a first security filter module. This data structure comprises at least a list of the identifiers of the first filter rules applied. In addition, the data structure can contain further information, such as timestamps or metadata about the applied rules, without limiting the scope of protection of the present disclosure. The data structure is inserted into a defined optional header field of the data packets. The format and the maximum size of the header field are specified in more detail below. The information in the header field can be encrypted and digitally signed to ensure the integrity and authenticity of the information. Suitable encryption methods are, for example, AES, and suitable signature methods are, for example, RSA.

The example method according to the present disclosure can significantly improve security and efficiency by allowing multiple security filter modules to cooperate—hence cooperative filtering. In other words, the method according to the present disclosure introduces an approach to filtering that incorporates the descriptions of the filter rules into the data traffic itself, thus enabling a better informed and coordinated response to potential threats.

“Taking into account the description” can be understood to mean a process in which a second security filter module evaluates the description of the first filter rules applied, which description is contained in the header field of the data packet. The second security filter module can perform decryption and signature verification. It uses the contained identifiers to check which first filter rules have already been applied by the first security filter module. First filter rules, the identifiers of which are contained in the description, are not reapplied by the second security filter module. The second security filter module, in turn, adds the identifiers of the second filter rules it applies, which differ from the first filter rules, to the description before forwarding the data packet.

The example method according to the present disclosure comprises in particular a sequencing of multiple security filter modules in a communication network, wherein each security filter module can filter the data traffic on the basis of different filter rules.

The first security filter module can now add a relevant description of filter rules applied to the data packets of the data traffic before they are forwarded to the next, or second, security filter module. The second security filter module can then use this description to apply its own filter rules more precisely and to avoid redundancy. This allows the method according to the present disclosure to increase security and efficiency in the communication network.

Advantageously, within the scope of the present disclosure, it may be provided for the insertion to comprise:
encrypting and/or certifying the description of the first filter rules.

The data traffic can be transmitted both confidentially and authentically due to encryption and certification. Encryption involves converting the contents of individual data packets of the data traffic into a form unreadable to unauthorized persons, in particular using cryptographic methods such as symmetric (AES) or asymmetric (RSA) encryption. Certification is done, for example, via digital certificates issued by a trusted Certificate Authority (CA) that can confirm the identity of a sender. In combination with digital signatures generated using the sender's private key, a recipient can verify both the integrity and authenticity of the data traffic. This ensures that data traffic cannot be altered unnoticed, or viewed by third parties during transmission.

It may be advantageous if, within the scope of the present disclosure, the description of the first filter rules is inserted into a defined header field of individual data packets of the filtered data traffic. This enables, in particular, efficient and transparent transmission of descriptions between the security filter modules, without requiring additional infrastructure or communication steps.

Furthermore advantageously, it may be provided for the method to further comprise:
defining respective identifiers for all filter rules, for example specific bits that are set in each case,
providing the defined identifiers to all security filter modules in the communication network, for example centrally by a, or the, centralized data processing device or decentrally from security module to security module, for example by adding the identifiers as additional information to the filtered data traffic,
   wherein, during the insertion, the corresponding identifiers of the first filter rules are inserted into the filtered data traffic as the description of the first filter rules, wherein the identifiers of the first filter rules are in particular encoded into individual data packets of the filtered data traffic. This allows the second security filter module to ascertain, on the basis of the identifiers, which filter rules have already been applied by the first security filter module as the first filter rules during filtering. In this way, efficient and secure administration of filter rules in the communication network can be achieved. The use of central identifiers for the filter rules simplifies in particular an exchange of information between the security filter modules. By encoding the identifiers into individual data packets, a transparent and traceable process can be ensured.

Identifiers can be understood to mean unique identifiers for each defined filter rule. These identifiers are generated centrally by an administrative instance present in the communication network or by an external administrative instance and distributed to all security filter modules in the network. The type of administrative instance is not essential for the present disclosure. The identifiers are permanently assigned to the filter rules and enable an efficient and compact representation of the rules in the description.

Optionally, it may be provided for the method to further comprise:
assigning specific filter rules to specific security filter modules in the communication network, in particular specific filter rules as the first filter rules to the first security filter module and further specific filter rules as the second filter rules to the second security filter module, taking into account individual computing power and/or locations of the specific security filter modules.

The assignment of filter rules can be automated by an assignment algorithm that takes into account the individual computing power and/or locations of the security filter modules. An example of such an algorithm is a weighted round-robin algorithm.

This offers the advantage of enabling an efficient distribution of filter rules across the various security filter modules. By taking into account individual computing power and locations, the security filter modules can be used optimally, which can lead to improved resource management and overall efficiency.

A further advantage of the present disclosure can be achieved if a centralized data processing device is provided for the assignment in order to configure successive security filter modules, in particular the first security filter module and the second security filter module, accordingly. This centralized data processing device can assign specific filter rules to the first and the second security filter module, and possibly to further successive security filter modules. This centralized configuration enables an efficient and uniform distribution of the filter rules to the various security filter modules, which distribution can advantageously take into account the individual computing power and locations of the different security filter modules.

In a further possibility, it can be provided that the method further comprises:
dynamically determining the respective filter rules of the security filter modules, in particular the first filter rules and the second filter rules, on the basis of a currently available computing capacity of the security filter modules, in particular the first security filter module and/or the second security filter module, and/or on the basis of a current utilization of the communication network.

In this way, it is possible for the computing power of the security filter modules to be used more efficiently. By dynamically determining the filter rules, the load on the security filter modules can be adapted to their current capacity and the current utilization of the communication network. This improves in particular an overall performance of the security filter modules and can minimize the risk of overload situations, especially under changed network conditions.

The present disclosure also relates to a computer program, in particular a computer program product, comprising commands which, when the computer program is executed by at least one computer, cause the computer to carry out the method according to the present disclosure. The computer program according to the present disclosure thus delivers the same advantages as have been described in detail with reference to a method according to the present disclosure.

The present disclosure also relates to a data processing device configured to carry out the method according to the present disclosure. For example, at least one computer which executes the computer program according to the present disclosure can be provided as the device. The computer may have at least one processor for executing the computer program. A non-volatile data memory may also be provided, in which the computer program is stored and from which the computer program can be read by the processor for execution.

The present disclosure may also relate to a computer-readable storage medium which comprises the computer program according to the present disclosure and/or commands which, when executed by at least one computer, cause the computer to carry out the method according to the present disclosure. The storage medium is formed, for example, as a data memory such as a hard drive and/or a non-volatile memory and/or a memory card. The storage medium may be integrated into the computer, for example.

Furthermore, the method according to the present disclosure may also be designed as a computer-implemented method. Alternatively or additionally, at least one of the disclosed method steps may be computer-implemented and/or performed automatically.

Further advantages, features and details of the present disclosure can be found in the following description, in which exemplary embodiments of the present disclosure are described in detail with reference to the figures. The features mentioned herein may be essential to the present disclosure in each case, either individually or in any combination.

### BRIEF DESCRIPTION OF THE DRAWINGS

FIG. 1 is a schematic visualization of a method, a device, a storage medium and a computer program according to exemplary embodiments of the present disclosure.

FIG. 2 is a schematic representation of a communication network according to exemplary embodiments of the present disclosure.

### DETAILED DESCRIPTION OF EXAMPLE EMBODIMENTS

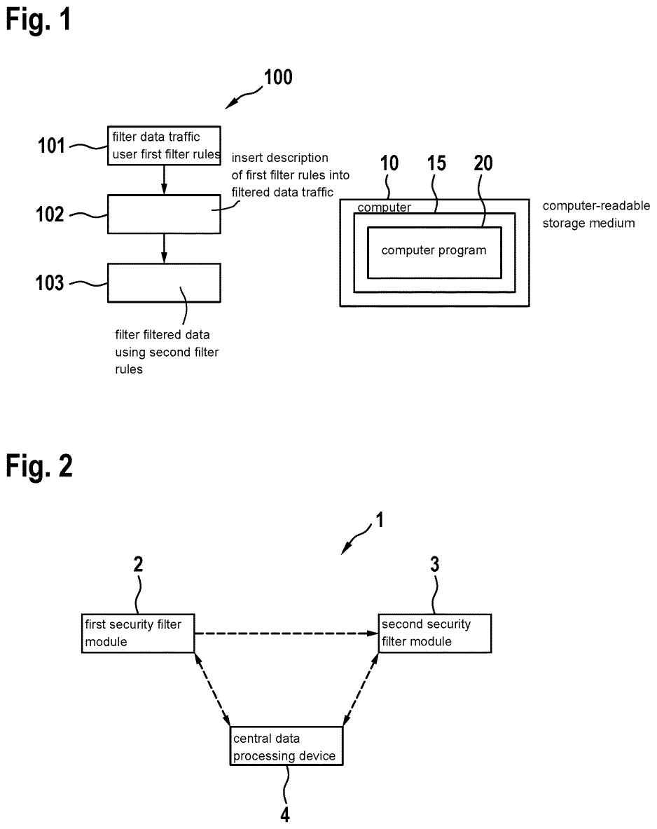

FIG. 1 schematically shows a method 100, a device 10, a storage medium 15, and a computer program 20 according to exemplary embodiments of the present disclosure.

FIG. 1 shows in particular an exemplary embodiment of a method 100 for cooperatively filtering data traffic in a communication network 1. In a first step 101, the data traffic is filtered by a first security filter module 2 on the basis of first filter rules. In a second step 102, a description of the first filter rules is inserted into the filtered data traffic. In a third step 103, the filtered data traffic is filtered on the basis of second filter rules by a second security filter module 3, taking into account the inserted description of the first filter rules.

FIG. 2 is a schematic representation of a communication network 1 according to exemplary embodiments of the present disclosure.

In this communication network, preferably a first security filter module 2 and a second security filter module 3 are arranged in series to sequentially filter the data traffic. A centralized data processing device 4 may be further provided, which can assign specific filter rules to respective specific security filter modules 2,3 in the communication network 1.

According to the present disclosure, performance and efficiency of security filter modules, in particular firewalls, can be improved by introducing cooperation between them. In conventional configurations, multiple security filter modules along a network path of a communication network 1 can redundantly apply the same filter rules, which can lead to unnecessary processing and delays. This redundancy has a negative impact in particular on the overall performance and efficiency of the communication network 1.

Furthermore, the present disclosure is specifically aimed at overcoming challenges related to resource utilization and scalability in arrangements of multiple security filter modules. Conventional setups often struggle in particular to use computing resources effectively and to adapt to the increasing demands of the communication network 1.

By addressing these specific challenges and shortcomings, the present disclosure can improve the performance of security filter modules by reducing latency, optimizing computing resource utilization, and/or improving scalability. This means that the present disclosure is specifically aimed at making security filter modules more efficient and enabling them to handle more demanding network loads without compromising security.

According to the present disclosure, inefficiency and performance limitations of conventional firewall systems can be overcome by enabling cooperation between successive security filter modules. The previous security filter module can share a description of applied filter rules with at least one subsequent security filter module.

This exchange of information allows the subsequent security filter modules to avoid redundant filtering if filter rules have already been applied by a different, preceding security filter module. This allows the present disclosure to optimize the filtering process, reduce unnecessary processing, and improve overall performance and efficiency.

The collaborative security filter module solution according to the present disclosure can provide a number of advantages. By eliminating redundant filtering, the present disclosure can reduce unnecessary processing, which can lead to faster and more efficient filtering of the data traffic in the communication network 1. This improves in particular overall system efficiency and enables the processing of higher data traffic volumes. The present disclosure can also minimize latency by eliminating double filtering and ensuring smooth and fast network traffic through the security filter modules. This leads in particular to reduced delays and improved response times. The optimized filtering processes and improved performance provided by the present disclosure can also improve network protection. By avoiding redundant filtering and ensuring efficient data traffic, unauthorized access and cyber threats can be better detected and prevented, thereby increasing overall network security.

The present disclosure introduces in particular a collaborative mechanism that can improve the efficiency of successive security filter modules in a network path. This mechanism can allow a previous security filter module to share a description of applied filter rules with at least one subsequent security filter module. For this purpose, the previous security filter module can encrypt and/or certify the description of the applied filter rules and thus securely insert it into the filtered traffic. This description of the applied filter rules can then be transmitted, for example as a header field, to at least one subsequent security filter module. After receiving the filtered data traffic, the at least one subsequent security filter module can access this header field and avoid redundant filtering for already applied filter rules. By eliminating the need for redundant application of the same filter rules, this innovative solution significantly reduces unnecessary processing and latency and can thus improve overall performance.

The information about the applied filter rules can be inserted as encrypted and certified data to ensure the security and integrity of the firewalls' cooperation. Encrypting the information makes it much more difficult for unauthorized persons to manipulate or falsify the data. Certification can also ensure authenticity of the information, making it more difficult for attackers to pose as a valid security filter module and falsely claim to have executed certain filter rules.

In order to successfully implement the proposed solution, it may be essential for all security filter modules involved in the cooperation to support the header field. At least, it is necessary in particular for the next and every subsequent security filter module involved in the cooperation to have the ability to understand and identify this header field.

To minimize the amount of additional information that is added to individual data packets or header fields in order to transmit the description of the filter rules, an efficient approach according to exemplary embodiments of the present disclosure may consist in using centrally defined and communicated identifiers for these filter rules. These identifiers, which are each assigned in particular to different filter rules, can then be transmitted to all relevant security filter modules. Once the security filter module is set up, it can encode the filter rules directly into the data packets of the data traffic using these identifiers. By applying this approach, the amount of additional data added to the data packets can be minimized, thereby reducing network overhead.

In scenarios where basic or standard filter rules are sufficient to be applied by a single security filter module, the collaborative mechanism can still be used to increase efficiency. In that case, if the packet is processed by a single security filter module and the basic filter rules are applied, they can be securely added to the data packet as a description in the header field. Subsequent security filter modules in the network path can then reference this header field and recognize that the basic filter rules have already been applied, allowing them to focus solely on implementing non-generic filter rules specific to their security filter module. In particular, the additional header information added to the packet as a description of the applied filter rules would be extremely limited, and would preferably only indicate whether the (network-wide defined) basic filter rules were executed or not.

By implementing intelligent configuration techniques, the application of specific filter rules can be distributed across different security filter modules, for example on the basis of their individual computing power, location and/or other capabilities. This approach can optimize computing resource utilization and ensure that each security filter module is assigned filter rules that match its strengths. To facilitate this process, a centralized coordination and administrative unit in the form of a centralized data processing device 4 can be used to configure successive security filter modules accordingly. This centralized data processing device 4 could serve as a trust anchor for all cooperating security filter modules and could be responsible for coordinating and optimizing the distribution of filter rules to the security filter modules. By using this intelligent configuration approach, overall efficiency and effectiveness can be significantly improved.

The collaborative security filter modules according to the present disclosure can offer significant advantages in various areas, in particular in complex network architectures with security filter modules and demanding applications. One such area is, for example, the industrial sector, where applications such as automation, industrial control and industrial IoT can greatly benefit from improved connectivity and security provided by the method according to the present disclosure.

The above description of the embodiments describes the present disclosure exclusively in the context of examples. Of course, individual features of the embodiments, provided they are technically feasible, can be freely combined with one another without departing from the scope of the present disclosure.

1-10. (canceled)

11. A method for cooperatively filtering data traffic in a communication network, comprising the following steps:
filtering the data traffic based on first filter rules using a first security filter module;
inserting a description of the first filter rules into the filtered data traffic; and
filtering the filtered data traffic based on second filter rules using a second security filter module, taking into account the inserted description of the first filter rules.

12. The method according to claim 11, wherein the inserting includes: encrypting and/or certifying the description of the first filter rules.

13. The method according to claim 11, wherein the description of the first filter rules is inserted into a defined header field of individual data packets of the filtered data traffic.

14. The method according to claim 11, wherein the method further comprises:
defining respective identifiers for all filter rules; and
providing the defined identifiers to all security filter modules in the communication network including the first security filter module and the second security filter module;
wherein, during the inserting, the corresponding identifiers of the first filter rules are inserted into the filtered data traffic as the description of the first filter rules, wherein the identifiers of the first filter rules are encoded into individual data packets of the filtered data traffic.

15. The method according to claim 11, wherein the method further comprises:
assigning specific filter rules to specific security filter modules in the communication network, the assigning of the specific rules including assigning the specific filter rules as the first filter rules to the first security filter module and further specific filter rules as the second filter rules to the second security filter module, taking into account individual computing power and/or locations of the specific security filter modules.

16. The method according to claim 15, wherein a centralized data processing device is provided for the assigning of the specific filter rules in order to configure successive security filter modules including the first security filter module and the second security filter module.

17. The method according to claim 11, wherein the method further comprises:
dynamically determining the first filter rules and the second filter rules of the first and second security filter module at least one of: (i) based on a currently available computing capacity of the first security filter module and/or the second security filter module, or (ii) based on a current utilization of the communication network.

18. A device for data processing configured to cooperatively filter data traffic in a communication network, the device configured to perform the following steps:
filtering the data traffic based on first filter rules using a first security filter module;
inserting a description of the first filter rules into the filtered data traffic; and
filtering the filtered data traffic based on second filter rules using a second security filter module, taking into account the inserted description of the first filter rules.

19. A non-transitory computer-readable storage medium on which are stored commands for cooperatively filtering data traffic in a communication network, the commands, when executed by at least one computer, causing the at least one computer to perform the following steps comprising:
filtering the data traffic based on first filter rules using a first security filter module;
inserting a description of the first filter rules into the filtered data traffic; and
filtering the filtered data traffic based on second filter rules using a second security filter module, taking into account the inserted description of the first filter rules.
